(19) United States
(12) Patent Application Publication
(10) Pub. No.: US 2024/0381421 A1
(43) Pub. Date: Nov. 14, 2024

(54) METHOD AND APPARATUS FOR TRANSMISSIONS VIA UNLICENSED RADIO CHANNELS

(71) Applicant: Nokia Technologies Oy, Espoo (FI)

(72) Inventors: Claudio ROSA, Aalborg (DK); Timo Erkki LUNTTILA, Espoo (FI); Roberto MALDONADO, Aalborg (DK); Ping-Heng KUO, Cambridge (GB)

(21) Appl. No.: 18/293,205

(22) PCT Filed: Aug. 10, 2021
(86) PCT No.: PCT/EP2021/072281

§ 371 Date: Jan. 29, 2024

(51) Int. Cl. H04W 74/0816; H04W 72/1268

(52) U.S. Cl. CPC H04W 74/0816; H04W 72/1268

(57) ABSTRACT

A technique, comprising: storing, at a user equipment, information about a sequence of uplink grants for the user equipment to make uplink transmissions via one or more radio channels of a plurality of unlicensed radio channels; and in response to data becoming transmission-ready at the user equipment with one or more intervening uplink grants before the earliest opportunity to attempt to transmit the data via a first unlicensed radio channel currently activated at the user equipment, activating a second unlicensed radio channel, and attempting to transmit the data via the second unlicensed radio channel at an uplink grant of the one or more intervening uplink grants.

### TECHNICAL FIELD

The present disclosure relates to apparatus, a method, and a computer program, and in particular but not exclusively to apparatus, methods and computer programs for transmissions via unlicensed radio channels.

### BACKGROUND

Some communication systems may involve a user equipment making transmissions at scheduled uplink grants via unlicensed radio channels. The possibility for a user equipment to attempt a transmission at a scheduled uplink grant via an unlicensed radio channel radio channel may, for example, depend on one or more channel access rules particular to the unlicensed channel.

### SUMMARY

A method, comprising: storing, at a user equipment, information about a sequence of uplink grants for the user equipment to make uplink transmissions via one or more radio channels of a plurality of unlicensed radio channels; and in response to data becoming transmission-ready at the user equipment with one or more intervening uplink grants before the earliest opportunity to attempt to transmit the data via a first unlicensed radio channel currently activated at the user equipment, activating a second unlicensed radio channel, and attempting to transmit the data via the second unlicensed radio channel at an uplink grant of the one or more intervening uplink grants.

Attempting to transmit the data via the second unlicensed radio channel may comprise attempting to transmit the data at the earliest uplink grant of the one or more intervening uplink grants.

The method may comprise switching to the second unlicensed radio channel in response to a determination at the user equipment that the second radio channel has a fixed frame period starting in alignment with the next uplink grant.

The method may comprise switching to the second unlicensed radio channel in response to a determination at the user equipment that the second radio channel has an index value related in a predetermined way to an index value of the first radio channel.

The sequence of uplink grants may comprise a periodic sequence of uplink grants.

The one or more intervening uplink grants may not align with the start of a fixed frame period for the first unlicensed radio channel, and may not be within a channel occupancy time of a fixed frame period for the first unlicensed radio channel for which a successful channel access procedure by the user equipment is valid.

The second unlicensed radio channel may be one of a plurality of unlicensed radio channels including resource blocks for which the user equipment is configured by a radio access network node to make data transmissions, and the start time of a next fixed frame period for the second unlicensed radio channel may be earlier than the start times of next fixed frame periods for the other unlicensed radio channels of the plurality of unlicensed radio channels.

Attempting to transmit the data via the second unlicensed radio channel may comprise attempting a channel access procedure for access to the second unlicensed channel in a fixed frame period starting in alignment with one of the one or more intervening uplink grants.

The method may comprise: in response to the channel access procedure being successful, transmitting the data within a channel occupancy time starting at the start of the fixed frame period for the second unlicensed radio channel.

The method may comprise transmitting further data via the second unlicensed radio channel at one more later uplink grants within the channel occupancy time starting at the start of the fixed frame period for the second unlicensed radio channel.

The method may comprise: in response to having further data transmission-ready in time for transmission at a later uplink grant within the channel occupancy time of the fixed frame period for the second unlicensed radio channel after no data transmission at a preceding uplink grant within the channel occupancy time of the fixed frame period for the second unlicensed radio channel, attempting transmission of the further data via the second unlicensed radio channel.

The method may comprise: in response to having further data transmission-ready in time for transmission at a later uplink grant within the channel occupancy time of the fixed frame period for the second unlicensed radio channel after no data transmission by the user equipment at a preceding uplink grant within the channel occupancy time of the fixed frame period for the second unlicensed radio channel, attempting transmission of the further data via the second unlicensed radio channel or via another unlicensed radio channel, depending on whether no data transmission at the preceding uplink grant was a result of no data being transmission-ready for transmission at the preceding uplink grant, or the result of a channel access failure to make a data transmission at the preceding uplink grant.

The first and second unlicensed radio channels may comprise 20 MHz channels.

Attempting to transmit the data via the second unlicensed radio channel may comprise attempting to transmit the data via a set of resource blocks within the second 20 MHz channel.

Apparatus, comprising: means for storing information about a sequence of uplink grants for the apparatus to make uplink transmissions via one or more radio channels of a plurality of unlicensed radio channels; and means for, in response to data becoming transmission-ready with one or more intervening uplink grants before the earliest opportunity to attempt to transmit the data via a first unlicensed radio channel currently activated at the apparatus, activating a second unlicensed radio channel, and attempting to transmit the data via the second unlicensed radio channel at an uplink grant of the one or more intervening uplink grants.

The means for attempting to transmit the data via the second unlicensed radio channel may comprise means for attempting to transmit the data at the earliest uplink grant of the one or more intervening uplink grants.

The apparatus may comprise means for switching to the second unlicensed radio channel in response to a determination that the second radio channel has a fixed frame period starting in alignment with the next uplink grant.

The apparatus may comprise means for switching to the second unlicensed radio channel in response to a determination that the second radio channel has an index value related in a predetermined way to an index value of the first radio channel.

The sequence of uplink grants may comprise a periodic sequence of uplink grants.

The one or more intervening uplink grants may not align with the start of a fixed frame period for the first unlicensed radio channel, and may not be within a channel occupancy time of a fixed frame period for the first unlicensed radio channel for which a successful channel access procedure by the apparatus is valid.

The second unlicensed radio channel may be one of a plurality of unlicensed radio channels including resource blocks for which the apparatus is configured by a radio access network node to make data transmissions, and the start time of a next fixed frame period for the second unlicensed radio channel may be earlier than the start times of next fixed frame periods for the other unlicensed radio channels of the plurality of unlicensed radio channels.

The means for attempting to transmit the data via the second unlicensed radio channel may comprise means for attempting a channel access procedure for access to the second unlicensed channel in a fixed frame period starting in alignment with one of the one or more intervening uplink grants.

The apparatus may comprise means for, in response to the channel access procedure being successful, transmitting the data within a channel occupancy time starting at the start of the fixed frame period for the second unlicensed radio channel.

The apparatus may comprise means for transmitting further data via the second unlicensed radio channel at one more later uplink grants within the channel occupancy time starting at the start of the fixed frame period for the second unlicensed radio channel.

The apparatus may comprise means for, in response to having further data transmission-ready in time for transmission at a later uplink grant within the channel occupancy time of the fixed frame period for the second unlicensed radio channel after no data transmission at a preceding uplink grant within the channel occupancy time of the fixed frame period for the second unlicensed radio channel, attempting transmission of the further data via the second unlicensed radio channel.

The apparatus may comprise means for, in response to having further data transmission-ready in time for transmission at a later uplink grant within the channel occupancy time of the fixed frame period for the second unlicensed radio channel after no data transmission at a preceding uplink grant within the channel occupancy time of the fixed frame period for the second unlicensed radio channel, attempting transmission of the further data via the second unlicensed radio channel or via another unlicensed radio channel, depending on whether no data transmission at the preceding uplink grant was a result of no data being transmission-ready for transmission at the preceding uplink grant, or the result of a channel access failure to make a data transmission at the preceding uplink grant.

The first and second unlicensed radio channels may comprise 20 MHz channels.

The means for attempting to transmit the data via the second unlicensed radio channel may comprise means for attempting to transmit the data via a set of resource blocks within the second 20 MHz channel.

Apparatus comprising: at least one processor; and at least one memory including computer program code, the at least one memory and computer program code configured to, with the at least one processor, cause the apparatus to perform: storing information about a sequence of uplink grants for the apparatus to make uplink transmissions via one or more radio channels of a plurality of unlicensed radio channels; and in response to data becoming transmission-ready with one or more intervening uplink grants before the earliest opportunity to attempt to transmit the data via a currently activated first unlicensed radio channel, activating a second unlicensed radio channel, and attempting to transmit the data via the second unlicensed radio channel at an uplink grant of the one or more intervening uplink grants.

Attempting to transmit the data via the second unlicensed radio channel may comprise attempting to transmit the data at the earliest uplink grant of the one or more intervening uplink grants.

The at least one memory and computer program code may be configured to, with the at least one processor, cause the apparatus to switch to the second unlicensed radio channel in response to a determination that the second radio channel has a fixed frame period starting in alignment with the next uplink grant.

The at least one memory and computer program code may be configured to, with the at least one processor, cause the apparatus to: switch to the second unlicensed radio channel in response to a determination that the second radio channel has an index value related in a predetermined way to an index value of the first radio channel.

The sequence of uplink grants may comprise a periodic sequence of uplink grants.

The one or more intervening uplink grants may not align with the start of a fixed frame period for the first unlicensed radio channel, and may not be within a channel occupancy time of a fixed frame period for the first unlicensed radio channel for which a successful channel access procedure by the apparatus is valid.

The second unlicensed radio channel may be one of a plurality of unlicensed radio channels including resource blocks for which the apparatus is configured by a radio access network node to make data transmissions, and the start time of a next fixed frame period for the second unlicensed radio channel may be earlier than the start times of next fixed frame periods for the other unlicensed radio channels of the plurality of unlicensed radio channels.

Attempting to transmit the data via the second unlicensed radio channel may comprise attempting a channel access procedure for access to the second unlicensed channel in a fixed frame period starting in alignment with one of the one or more intervening uplink grants.

The at least one memory and computer program code may be configured to, with the at least one processor, cause the apparatus to: in response to the channel access procedure being successful, transmitting the data within a channel occupancy time starting at the start of the fixed frame period for the second unlicensed radio channel.

The at least one memory and computer program code may be configured to, with the at least one processor, cause the apparatus to: transmit further data via the second unlicensed radio channel at one more later uplink grants within the channel occupancy time starting at the start of the fixed frame period for the second unlicensed radio channel.

The at least one memory and computer program code may be configured to, with the at least one processor, cause the apparatus to: in response to having further data transmission-ready in time for transmission at a later uplink grant within the channel occupancy time of the fixed frame period for the second unlicensed radio channel after no data transmission at a preceding uplink grant within the channel occupancy time of the fixed frame period for the second unlicensed radio channel, attempt transmission of the further data via the second unlicensed radio channel.

The at least one memory and computer program code may be configured to, with the at least one processor, cause the apparatus to: in response to having further data transmission-ready in time for transmission at a later uplink grant within the channel occupancy time of the fixed frame period for the second unlicensed radio channel after no data transmission by the user equipment at a preceding uplink grant within the channel occupancy time of the fixed frame period for the second unlicensed radio channel, attempt transmission of the further data via the second unlicensed radio channel or via another unlicensed radio channel, depending on whether no data transmission at the preceding uplink grant was a result of no data being transmission-ready for transmission at the preceding uplink grant, or the result of a channel access failure to make a data transmission at the preceding uplink grant.

The first and second unlicensed radio channels may comprise 20 MHz channels.

Attempting to transmit the data via the second unlicensed radio channel may comprise attempting to transmit the data via a set of resource blocks within the second 20 MHz channel.

Apparatus, comprising: storing circuitry for storing information about a sequence of uplink grants for the apparatus to make uplink transmissions via one or more radio channels of a plurality of unlicensed radio channels; and activating circuitry for, in response to data becoming transmission-ready at the user equipment with one or more intervening uplink grants before the earliest opportunity to attempt to transmit the data via a first unlicensed radio channel currently activated at the user equipment, activating a second unlicensed radio channel, and attempting to transmit the data via the second unlicensed radio channel at an uplink grant of the one or more intervening uplink grants.

A computer readable medium comprising program instructions stored thereon for performing: storing, at a user equipment, information about a sequence of uplink grants for the user equipment to make uplink transmissions via one or more radio channels of a plurality of unlicensed radio channels; and in response to data becoming transmission-ready at the user equipment with one or more intervening uplink grants before the earliest opportunity to attempt to transmit the data via a first unlicensed radio channel currently activated at the user equipment, activating a second unlicensed radio channel, and attempting to transmit the data via the second unlicensed radio channel at an uplink grant of the one or more intervening uplink grants.

A computer program comprising computer executable code which when run on at least one processor is configured to cause an apparatus at least to: store information about a sequence of uplink grants for the apparatus to make uplink transmissions via one or more radio channels of a plurality of unlicensed radio channels; and in response to data becoming transmission-ready at the user equipment with one or more intervening uplink grants before the earliest opportunity to attempt to transmit the data via a first unlicensed radio channel currently activated at the user equipment, activate a second unlicensed radio channel, and attempt to transmit the data via the second unlicensed radio channel at an uplink grant of the one or more intervening uplink grants.

A non-transitory computer readable medium comprising program instructions stored thereon for performing: storing, at a user equipment, information about a sequence of uplink grants for the user equipment to make uplink transmissions via one or more radio channels of a plurality of unlicensed radio channels; and in response to data becoming transmission-ready at the user equipment with one or more intervening uplink grants before the earliest opportunity to attempt to transmit the data via a first unlicensed radio channel currently activated at the user equipment, activating a second unlicensed radio channel, and attempting to transmit the data via the second unlicensed radio channel at an uplink grant of the one or more intervening uplink grants.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF THE FIGURES

Some example embodiments will now be described in further detail, by way of example only, with reference to the following examples and accompanying drawings, in which:

FIG. 1 illustrates an example system to which embodiments may be applied;

FIG. 2 shows a representation of an example of timing for accessing an unlicensed radio channel in some example embodiments;

FIG. 3 shows a representation of an example of an information element providing configured grant (CG) information to a user equipment in some example embodiments;

FIG. 4 shows a representation of an example of staggered FFP configurations and periodic uplink grants for a long term allowance in some example embodiments;

FIG. 5 shows a representation of an example of operations at a user equipment according to an example embodiment;

FIG. 6 shows a representation of an example of switching between unlicensed radio channels in accordance with the example operations of FIG. 5;

FIG. 7 shows a representation of an example of operations at a user equipment according to another example embodiment;

FIG. 8 shows a representation of an example of switching between unlicensed radio channels in accordance with the example operations of FIG. 7;

FIG. 9 shows a representation of an example of apparatus for implementing operations according to some example embodiments; and

FIG. 10 shows a representation of an example of non-volatile memory media.

### DETAILED DESCRIPTION

The following description makes mention of user equipments (UEs) operating according to 3GPP 5G, but the underlying technique is also applicable to other user equipments, such as e.g. user equipments operating according to later 3GPP releases.

The term “user equipment” here refers to any device, apparatus or component implementing user equipment functionality; and may include, for example, vehicles or other machinery implementing UE functionality.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

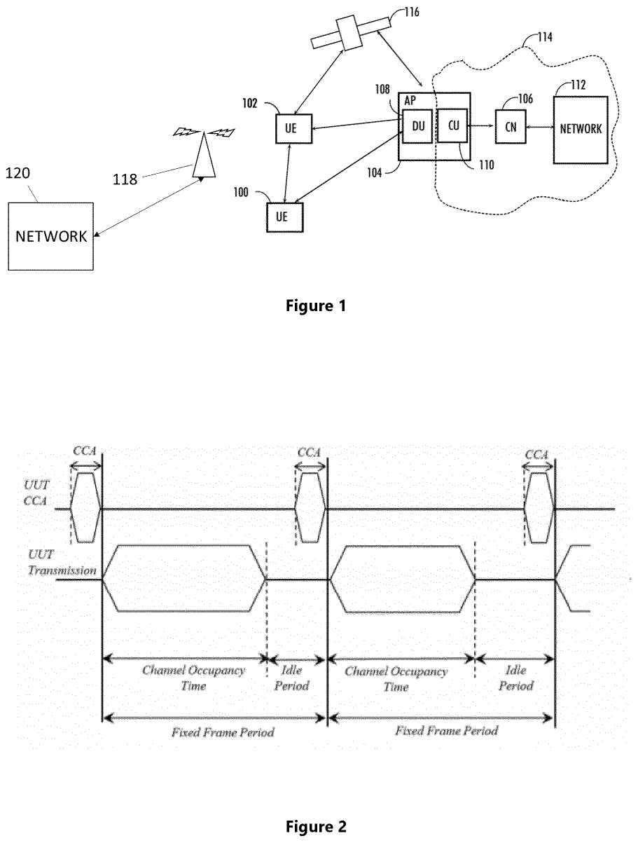

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

FIG. 1 shows devices 100 and 102. The devices 100 and 102 are configured to be in a wireless connection on one or more communication channels with a node 104. The node 104 is further connected to a core network 106. In one example, the node 104 may be an access node such as (e/g)NodeB serving devices in a cell. In one example, the node 104 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 106 (CN or next generation core NGC). Depending on the deployed technology, the (e/g)NodeB is connected to a serving and packet data network gateway (S-GW+P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Exemplary embodiments of a device having user equipment functionality comprise a user terminal, a terminal device, a mobile station, a mobile device, etc..

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz—cmWave, 6 or above 24 GHz—cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data.

This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 112, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 108) and non-real time functions being carried out in a centralized manner (in a centralized unit, CU 110).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node or by a gNB located on-ground or in a satellite.

It is clear to a person skilled in the art that the depicted system is only an example of a part of a radio access system and in practice, the system may comprise a plurality of (e/g)NodeBs, the device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

In example embodiments, uplink transmissions from UE 100 to gNB 104 at least partly utilise unlicensed spectrum. In some example embodiments, two or more 20 MHz channels within the unlicensed spectrum are utilised, in competition with one or more access points (APs) 118 operating according to one or more other radio access technologies (RATs), such as APs operating according to a IEEE 802.11 (Wi-Fi) protocol (Wi-Fi) and providing wireless access to a data network 120.

In the example embodiments described below, UE 100 is configured with independent and staggered frame periods for each unlicensed 20 MHz radio channel.

In these example embodiments, UE 100 is configured such that an attempt to access an unlicensed radio channel during a frame period is subject to at least the following two conditions: (i) the attempt is made immediately preceding the start of the frame period for a transmission at the start of the frame period, or (ii) for a transmission later in the frame period, that UE 100 made a transmission at the start of the frame period.

In these example embodiments, the unlicensed channels are in the 5 GHz and 6 GHz spectrum, and the channel access mechanism is a frame based equipment (FBE) mechanism, also referred to as semi-static channel occupancy. In these example embodiments, the channel access procedure is that specified in 3GPP TS 37.213 Section 4.3, whose entire content is herein incorporated by reference. With reference to FIG. 2: for each 20 MHz channel, time is divided into fixed frame periods (FFPs). Each FFP comprises a periodic channel-occupancy time (COT) followed by an idle period. The FFP duration (sum of the COT and idle period) may be within the range of 1 ms to 10 ms. The idle period may, for example, be equal to 5% of the FFP, or at least 100 microseconds, whichever is greater. The first transmission by UE 100 in a FFP may only be at the start of the FFP, and is subject to a successful clear channel assessment (CCA) (e.g. a Listen-Before-Talk (LBT) measurement) during a single observation slot (9 microseconds) within a 25 microsecond interval immediately before the start of the FFP. A LBT measurement for a 20 MHz channel involves UE 100 detecting the energy level in the 20 MHz channel. UE 100 determines that the channel is occupied if the detected energy level exceeds an energy detection (ED) threshold level. If the CCA immediately preceding the start of the FFP indicates that the channel is occupied, then (in accordance with regulations) UE 100 does not make any transmission at the start of the FFP, and does not may make any further channel access attempts for uplink transmissions via that channel during that FFP. On the other hand, if the CCA immediately preceding the start of the FFP indicates that the channel is clear (not occupied), UE 100 may make an uplink data transmission at the start of the FFP, and may make one or more further uplink data transmissions during that FFP subject to at least the following conditions: (a) the further data transmission is initiated at most 16 μs after the most recent data transmission within the FFP by the initiating device; or b) UE 100 performs a further CCA on the channel during a single observation slot (9 μs) within a 25 μs period ending immediately before UE 100 is to make the further data transmission, and the CCA result again indicates that the channel is clear.

According to example embodiments, gNB 104 indicates the FFP configuration for UE 100 (UE-FFP) for the plurality of 20 MHz channels to UE 100 through SIB1 (System Information Block 1) or dedicated RRC (Radio Resource Control) signalling. The UE-FFP duration (the sum of the COT period and the idle period) may, for example, be selected by gNB 104 from a predetermined group of values, such as e.g. {1 ms, 2 ms, 2.5 ms, 4 ms, 5 ms, 10 ms}. The idle period for a given sub-carrier spacing may be a predetermined minimum idle period divided by Ts (where Ts is the symbol duration of the sub-carrier spacing. The minimum idle period may be 5% of the FFP duration or 100 microseconds, whichever is greater (i.e. max (5% of FFP, 10microseconds).

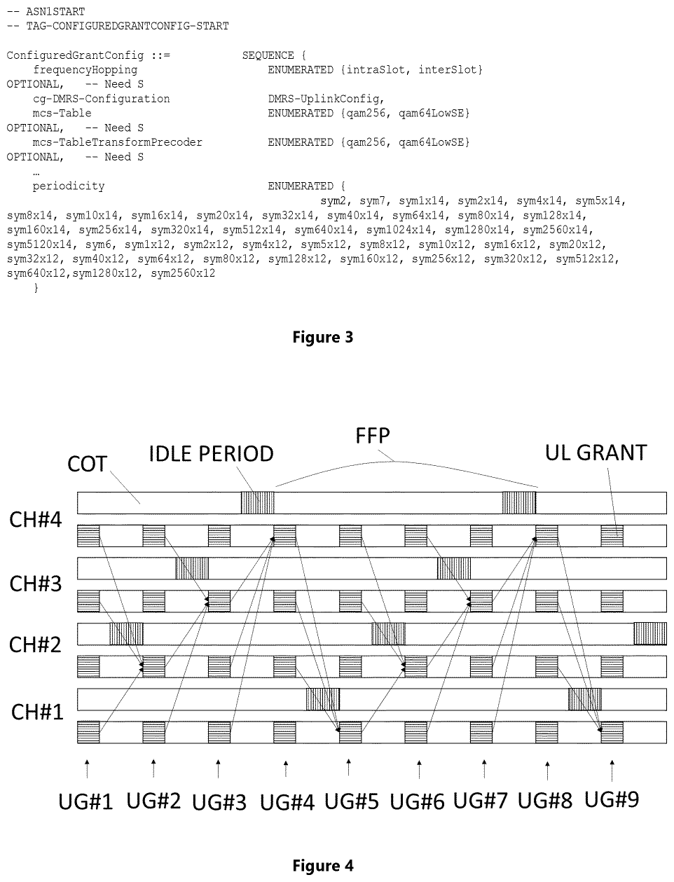

Additionally, there are further restrictions imposed by gNB 104 on when UE 100 can make uplink transmissions to gNB 104 via the unlicensed radio channels. UE 100 can only make an uplink transmission at uplink grants (frequency-time resources) dedicated to UE 100 by gNB 104. UE 100 can only make an uplink transmission via an unlicensed radio channel (via frequency resources (resource block (RB) set) granted by gNB 104 to UE 100 within the channel) at an uplink grant time, and only then if UE 100 has access to the unlicensed radio channel for a data transmission at the uplink grant time. In the example embodiments described below, UE 100 is provided by gNB 104 with a long-term allowance to make transmissions to gNB 104 on any one or more of a periodic sequence of preconfigured resources. In these example embodiments, the time period between successive uplink grants is shorter than the FFP duration. The time period between successive uplink grants may, for example, be as low as 2 OFDM symbols. FIG. 3 shows one example of a format for providing UE 100 with information about a configured grant (CG), including the periodicity of the grant.

FIG. 4 shows a representation of one example of a long-term allowance of uplink grants for UE 100 via frequency resources (RB sets) in respective four radio channels CH #1, CH #2, CH #3 and CH #4 in unlicensed spectrum. FIG. 4 also shows how the uplink grants relate in timing to the FFPs for the four radio channels CH #1, CH #2, CH #3 and CH #4. The FFPs are staggered between the four channels, such that for all uplink grants, there is at least one unlicensed radio channel whose FFP starts in alignment with the uplink grant. The arrows shown in FIG. 4 indicate how UE 100 may switch from a currently activated unlicensed radio channel to another unlicensed radio channel according to an example embodiment, in the event of data becoming transmission-ready with one or more intervening uplink grants before the earliest opportunity to attempt to transmit the data via the currently activated unlicensed radio channel.

Only one of the RB sets (e.g. only one of the RB sets from CH #1, CH #2, CH #3 or CH #4 in the example of FIG. 4) may be active at one time for configured grant (CG) physical uplink shared channel (PUSCH) transmissions by UE 100.

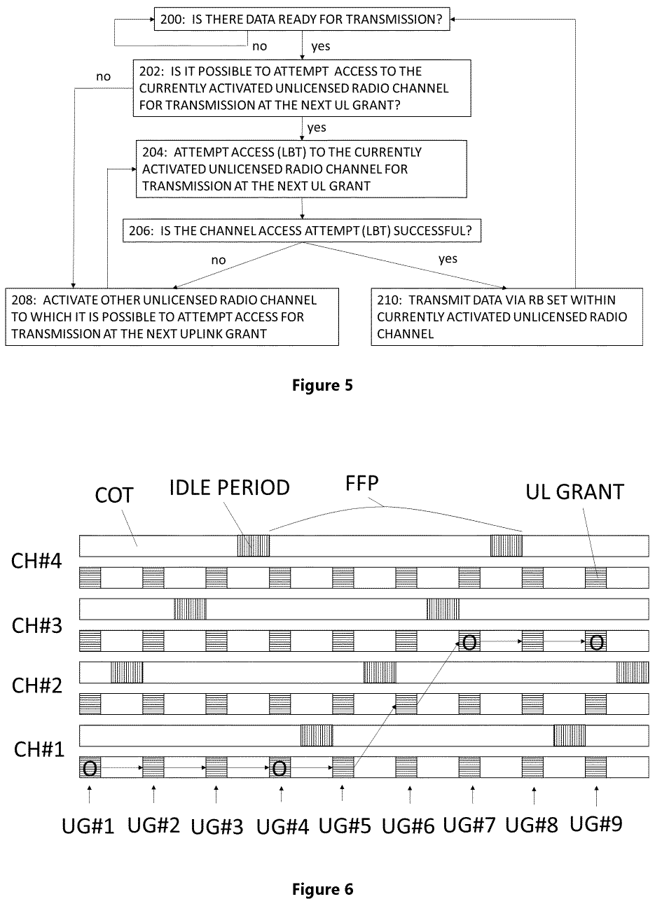

FIG. 5 shows a representation of an example of operations at UE 100 in some example embodiments. UE 100 has been granted a long-term allowance to attempt channel transmissions at periodic times on any one of a plurality of resource block (RB) sets (e.g. four RB sets in CH #1, CH #2, CH #3 and CH #4, respectively, in the example of FIG. 4). Each RB set is contained in a respective 20 MHz channel (CH #1, CH #2, CH #3, CH #4 in FIG. 4) within a bandwidth part (BWP) comprising a contiguous set of resource blocks. The BWP has a bandwidth of n multiples of 20 MHz, wherein n may e.g. be 2, 3, 4 or 5.

UE 100 adopts one of the four channels as the initially-active channel. The initially active channel may be explicitly specified by gNB 104. Alternatively, the initially active channel may be the 20 MHz channel having an FFP that starts in alignment with the UL grant that is next at the time of determining at UE 100 which channel to adopt as the initially active channel. Alternatively, the initially active channel is pre-determined to be the one having a predetermined index value, such as the channel with the highest index value, or the channel with the lowest index value.

UE 100 continuously checks whether it has data ready for uplink transmission (OPERATION 200). In more detail, UE checks whether there is data in the uplink transmission buffer.

In response to there being data ready for transmission, UE 100 determines if it is possible to attempt access to a currently activated unlicensed 20 MHz channel for transmission of the data at the next uplink grant (OPERATION 202). For example, if the next uplink grant coincides with the start of a FFP for the currently active channel, UE 100 can attempt access to the currently active channel for transmission of the data via the granted RB set within the currently active channel at the next uplink grant. Alternatively: if the next uplink grant does not coincide with the start of a FFP for the currently active channel, but the next uplink grant is within a FFP (for the currently active channel) that UE 100 determined to be clear (through CCA by UE 100 immediately preceding the start of the FFP), UE 100 can attempt to access the currently active channel for transmission of the data via the granted RB set within the currently active channel at the next uplink grant. As mentioned above, UE 100 may not need to do perform a new CCA, if the new data transmission is less than a predetermined duration of time after an earlier data transmission via the currently active channel.

In response to a determination at UE 100 that UE 100 can attempt access to the currently active channel for transmission of the data via the granted RB set in the currently active channel at the next uplink grant, UE 100 performs a LBT operation for the currently active channel immediately before the next uplink grant (OPERATION 204).

On the other hand, if OPERATION 202 indicates that UE 100 cannot attempt access to the currently active channel for transmission of the data via the granted RB set in the currently active channel at the next uplink grant, UE 100 deactivates the currently active channel, and activates another 20 MHz channel (having a staggered FFP relative to CH #1) to which it can attempt access for data transmission at the next uplink grant (OPERATION 208). More particularly, UE 100 determines which of the other 20 MHz channels have a FFP starting in alignment with the next uplink grant, and activates that 20 MHz channel (referred to here as CH #2) as the new currently active channel. UE 100 then proceeds to perform a LBT measurement for the new currently active channel immediately before the next uplink grant, i.e. immediately before the start of the FFP for the new currently active channel (OPERATION 204).

If the attempt at OPERATION 204 to access the currently active channel for transmission of the data at the next uplink grant succeeds, then UE 100 proceeds to transmit the data at the next uplink grant (OPERATION 210) via the granted RB set in the currently active channel.

On the other hand, if the attempt at OPERATION 204 to access the currently active channel for data transmission at the next uplink grant fails, then UE 100 deactivates the currently active channel, and activates another unlicensed 20 MHz channel (having a staggered FFP relative to the currently active channel) to which it can attempt access for data transmission at the next uplink grant (OPERATION 208). More particularly, UE 100 determines which of the other 20 MHz channels has a FFP starting in alignment with the next uplink grant, and activates that 20 MHz channel as the new currently active channel.

FIG. 6 shows one example of UE 100 switching between 20 MHz channels in unlicensed spectrum, according to the operations of FIG. 5. In FIG. 6, the arrows indicate switching between channels, and “O” indicates uplink grants at which UE 100 made an uplink transmission.

A successful CCA immediately before the start of a FFP (including UG #1) for a currently active channel CH #1 and another successful LBT operation immediately before UG #1 allows UE 100 to make an uplink data transmission at the uplink grant (UG #1) via the granted RB set in CH #1.

The successful CCA before the start of the FFP allows UE 100 to attempt further access to CH #1 later during the COT of the same FFP for CH #1. In this example: after making an uplink transmission at the start of the FFP for CH #1, UE 100 either (a) has no data to transmit at the next two uplink grants (UG #2 and UG #3), or (b) has data to transmit but is unable to transmit the data at UG #2 or UG #3 because of unsuccessful LBT operations.

UE 100 makes another uplink transmission at the 4^{th} uplink grant (UG #4) within the COT of the same FFP for CH #1. This uplink transmission at UG #4 may, for example, be a transmission of data that became ready for transmission only after the 3^{rd} uplink grant (UG #3). Alternatively, this uplink transmission at UG #4 may be a transmission of data that became transmission-ready before then, but that UE 100 was unable to transmit at UG #2 and UG #3 because of one or more unsuccessful LBT operations.

No uplink transmission is made by UE 100 at the next uplink grant (UG #5), which is outside the COT of the FFP in which UE 100 made the previous transmission at UG #4. The absence of an uplink transmission at UG #5 is either (a) because UE 100 has no data ready for transmission at this uplink grant UG #5, or (b) because UE 100 had data ready for transmission, but was unable to transmit the data because of an unsuccessful LBT operation immediately before the start of the new FFP for CH #1. In any case, the next opportunity for UE 100 to attempt to make a transmission via CH #1 would not be until UG #9, which is three uplink grants after the next uplink grant (UG #6).

UE 100 deactivates CH #1, and instead activates CH #2, having a FFP starting in alignment with the next uplink grant (UG #6).

No uplink transmission is made by UE at UG #6. The absence of an uplink transmission at UG #6 is either (a) because UE 100 has no data ready for transmission at this uplink grant UG #6, or (b) because UE 100 had data ready for transmission, but was unable to transmit the data because of an unsuccessful LBT operation for CH #2 immediately before the start of the FFP for CH #2. In any case, the next opportunity for UE 100 to attempt to make a transmission via the granted RB set in CH #2 would not be until three uplink grants after the next uplink grant (i.e. not until UG #10).

UE 100 deactivates CH #2, and instead activates CH #3, having a FFP starting in alignment with the next uplink grant (UG #7).

UE 100 makes an uplink transmission at UG #7 via the granted RB set in CH #3 (after a successful LBT operation for CH #3 immediately preceding the start of the FFP for CH #3). UE 100 is thus also allowed to attempt further transmissions during the COT of the same FFP for CH #3.

No uplink transmission is made by UE 100 at UG #8. The absence of an uplink transmission at UG #8 is again either (a) because UE 100 has no data ready for transmission at this uplink grant, or (b) because UE 100 has data ready for transmission, but was unable to transmit the data because of an unsuccessful LBT operation immediately before UG #8.

UE 100 makes a further uplink transmission via the granted RB set in CH #3 at UG #9. This transmission may, for example, be a transmission of data that became ready for transmission only after UG #8. Alternatively, this data may have been ready in time for transmission at UG #8, but UE was unable to transmit the data at UG #8 because of an unsuccessful LBT operation immediately before UG #8.

In the example of FIG. 5, UE maintains CH #3 as the active channel and makes UL transmissions via the granted RB set in CH #3, even when a new FFP is starting for the initially active channel (CH #1). According to one variation, UE 100 may instead fall back to the initially active channel CH #1 for the start of a new FFP for CH #1. In this variation, the initially-active channel may be a channel explicitly specified by gNB 104.

As mentioned above, UE 100 can only make uplink transmissions on one granted RB set at any one UL grant time. It is deterministic for both gNB 104 and UE 100 which RB set is to be used (i.e. which channel is active for UE).

This embodiment can achieve a reduction in UL latency, since the time to wait for the start of the next fixed frame period is reduced. CG-PUSCH detection at gNB 104 is not complex, since gNB can infer which RB-set (in which channel) is expected to be used by UE 100 in each UL CG occasion. gNB 104 may use resources on non-active RB sets for e.g. scheduled UL transmissions.

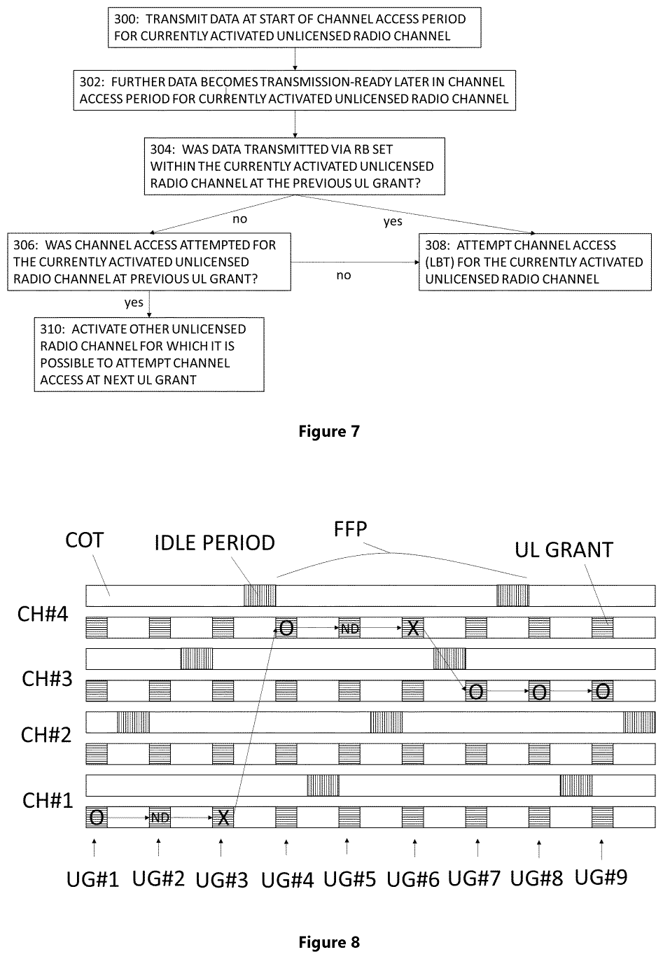

FIG. 7 shows a representation of another example of operations at UE 100 in another example embodiment.

UE 100 has had LBT success at the start of a FFP for a currently active channel, and makes an uplink transmission via the granted RB set in the currently active channel at an uplink grant aligning with the start of the FFP for the currently active channel (OPERATION 300).

Further data becomes transmission-ready at UE 100 later in the COT for the same FFP for the currently active channel (OPERATION 302).

UE 100 determines whether data was transmitted by UE 100 via the granted RB set within the currently active channel at the previous uplink grant (OPERATION 304).

If this determination at OPERATION 304 is positive, UE 100 performs a LBT measurement to attempt access to the currently active channel to transmit the data via the granted RB set within the currently active channel.

On the other hand, if the determination at OPERATION 304 is negative, UE 100 determines whether there was an attempt to access the currently active channel for an uplink transmission at the previous uplink grant (OPERATION 306).

If the determination at OPERATION 306 is positive: UE 100 deactivates the currently active channel; determines which other channel has a FFP starting in alignment with the next uplink grant for UE 100 (OPERATION 310); and activates that other channel as the new currently active channel.

On the other hand, if the determination at OPERATION 306 is negative, UE 100 performs a LBT measurement for the currently active channel to attempt access to the currently active channel to transmit the data via the granted RB set within the currently active channel (OPERATION 308).

FIG. 8 shows one example of channel switching at UE 100 following the operations of FIG. 7. In FIG. 8: the arrows indicate switching between 20 MHz channels; “O” indicates an UL grant at which UE 100 made an uplink transmission; “X” indicates an uplink grant at which UE 100 made no transmission because of a failed LBT operation; and “ND” indicates an uplink grant at which UE 100 made no transmission because there was no data ready for transmission.

Again, a successful CCA immediately before the start of a FFP (including UG #1) for a currently activated channel CH #1 and another successful LBT operation for CH #1 immediately before UG #1 has allowed UE 100 to make an uplink transmission at (UG #1) via the granted RB set within CH #1. The successful CCA immediately before the start of a FFP for CH #1 allows UE 100 to later attempt further channel access during the COT of the same FFP for CH #1, but UE 100 has no data to transmit at the next uplink grant UG #2. UE 100 does have data transmission-ready in time for UG #3, but UE is unable to transmit the data at UG #3 because of an unsuccessful LBT operation for CH #1 immediately before UG #3.

Since the absence of a transmission at UG #3 was because of an unsuccessful LBT operation for CH #1 immediately before UG #3, UE 100 determines to switch to CH #4, having a FFP starting in alignment with the next uplink grant (UG #4) for UE 100. An LBT operation for CH #4 immediately before the start of the new FFP for CH #4 (which is also immediately before the start of UG #4) allows UE 100 to transmit at UG #4, via the granted RB set within CH #4, the data that it failed to transmit at UG #3 via the granted RB set within CH #1.

The successful CCA immediately before the start of a FFP for CH #4 also allows UE 100 to later attempt further channel access during the COT of the same FFP for CH #4, but UE 100 has no data to transmit at the next uplink grant UG #5. UE 100 does have data transmission-ready in time for UG #6. Since the absence of a transmission at UG #5 was because there was no data transmission-ready for UG #5 (and not because of an unsuccessful LBT operation for CH #4 immediately before UG #5), UE 100 attempts to access the currently active channel CH #4 for transmission of data at UG #6. However, the LBT operation for CH #4 is not successful.

Since the absence of a transmission at UG #6 was because of an unsuccessful LBT operation for CH #4 immediately before UG #6 (and not because of there being no data transmission-ready for UG #6), UE 100 determines to switch to CH #3, having a FFP starting in alignment with the next uplink grant (UG #7) for UE 100. An LBT operation for CH #3 immediately before the start of the new FFP for CH #3 (which is also immediately before the start of UG #7) allows UE 100 to transmit at UG #7, via the granted RB set within CH #3, the data that it failed to transmit at UG #6 via the granted RB set in CH #4.

The successful CCA immediately before the start of the new FFP for CH #3 also allows UE 100 to attempt further channel access during the COT of the FFP for CH #3; and UE 100 makes further data transmissions at the next two uplink grants UG #8 and UG #9 via the granted RB set within CH #3, following successful LBT operations for CH #3 immediately before the start of UG #8 and UG #9.

According to some example embodiments, UE 100 may fallback to the initially active RB-set (e.g. RB set in CH #1) under certain conditions. For example, UE 100 may start a timer when first switching away from the initially active RB set; and upon expiry of the timer, UE 100 may automatically return to the initially active RB-set, regardless of the LBT status of the RB set currently active at that time. The value of this timer may be configured by gNB 104.

In the example embodiments described above, the channel switching at UE 100 involves UE 100 determining which channel has a FFP starting in alignment with the next UL grant. In other embodiments, UE 100 may be configured by gNB 104 to follow a predetermined switching pattern. For example, in the event of RB set #x (in channel #x) being the currently active RB set, and RB-set #x not being available at the next UL grant, UE 100 may be configured to deactivate RB set #x (in channel #x) and instead activate RB set #y (in channel #y), regardless of whether the FFP for channel #y starts in alignment with the next uplink grant. For example, UE 100 may be configured by gNB 104 such that UE always switches to a RB set having an index value y=x+1, wherein x is the index value of the currently activated RB set. With reference to the FFP configurations of the example of FIG. 4: UE 100 would thus follow the following switching pattern: CH #1→CH #2; CH #2→CH #3; CH #3→CH #4; CH #4→CH #1.

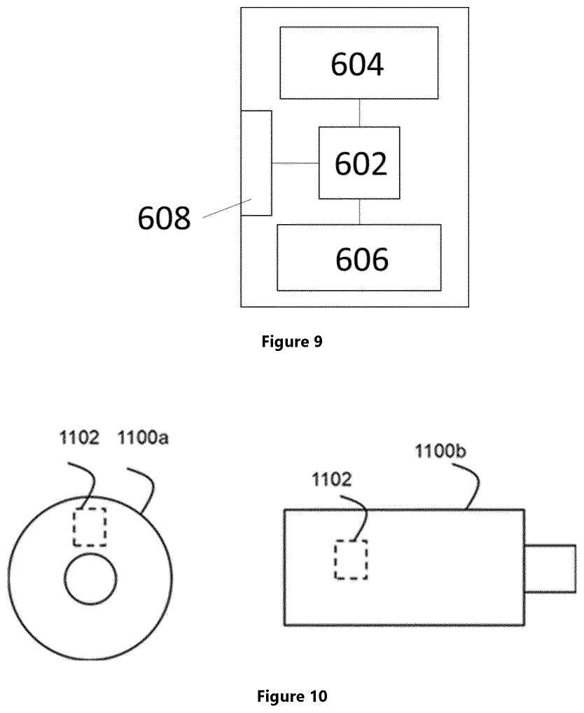

FIG. 9 illustrates an example of an apparatus for implementing the operations of UE 100 in the embodiments described above. The apparatus may comprise at least one processor 602 coupled to one or more interfaces 608 to e.g. other equipment for which the UE functionality provides radio communications. The at least one processor 602 is also coupled to a radio unit 604 including one or more antennas etc. for making and receiving radio transmissions. The at least one processor 602 may also be coupled to at least one memory 606. The at least one processor 602 may be configured to execute an appropriate software code to perform the operations described above. The software code may be stored in the memory 606

FIG. 10 shows a schematic representation of non-volatile memory media 1100a (e.g. computer disc (CD) or digital versatile disc (DVD)) and 1100b (e.g. universal serial bus (USB) memory stick) storing instructions and/or parameters 1102 which when executed by a processor allow the processor to perform one or more of the steps of the methods described previously.

It is to be noted that embodiments of the present invention may be implemented as circuitry, in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as the base stations or user equipment of the above-described embodiments.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as the user equipment or base stations of the above-described embodiments, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A method, comprising:
storing, at a user equipment, information about a sequence of uplink grants for the user equipment to make uplink transmissions via one or more radio channels of a plurality of unlicensed radio channels; and
in response to data becoming transmission-ready at the user equipment with one or more intervening uplink grants before the earliest opportunity to attempt to transmit the data via a first unlicensed radio channel currently activated at the user equipment, activating a second unlicensed radio channel, and attempting to transmit the data via the second unlicensed radio channel at an uplink grant of the one or more intervening uplink grants.

2. The method according to claim 1, wherein attempting to transmit the data via the second unlicensed radio channel comprises attempting to transmit the data at the earliest uplink grant of the one or more intervening uplink grants.

3. The method according to claim 2, comprising: switching to the second unlicensed radio channel in response to a determination at the user equipment that the second radio channel has a fixed frame period starting in alignment with the next uplink grant.

4. The method according to claim 1, comprising: switching to the second unlicensed radio channel in response to a determination at the user equipment that the second radio channel has an index value related in a predetermined way to an index value of the first radio channel.

5. The method according to claim 1, wherein the sequence of uplink grants comprises a periodic sequence of uplink grants.

6. The method according to claim 1, wherein the one or more intervening uplink grants do not align with the start of a fixed frame period for the first unlicensed radio channel, and are not within a channel occupancy time of a fixed frame period for the first unlicensed radio channel for which a successful channel access procedure by the user equipment is valid.

7.-28. (canceled)

29. An apparatus comprising: at least one processor; and at least one memory including computer program code, the at least one memory and computer program code configured to, with the at least one processor, cause the apparatus to perform:
storing information about a sequence of uplink grants for the apparatus to make uplink transmissions via one or more radio channels of a plurality of unlicensed radio channels; and
in response to data becoming transmission-ready with one or more intervening uplink grants before the earliest opportunity to attempt to transmit the data via a currently activated first unlicensed radio channel, activating a second unlicensed radio channel, and attempting to transmit the data via the second unlicensed radio channel at an uplink grant of the one or more intervening uplink grants.

30. The apparatus according to claim 29, wherein attempting to transmit the data via the second unlicensed radio channel comprises attempting to transmit the data at the earliest uplink grant of the one or more intervening uplink grants.

31. The apparatus according to claim 30, wherein the at least one memory and computer program code are configured to, with the at least one processor, cause the apparatus to switch to the second unlicensed radio channel in response to a determination that the second radio channel has a fixed frame period starting in alignment with the next uplink grant.

32. The apparatus according to claim 29, wherein the at least one memory and computer program code are configured to, with the at least one processor, cause the apparatus to: switch to the second unlicensed radio channel in response to a determination that the second radio channel has an index value related in a predetermined way to an index value of the first radio channel.

33. The apparatus according to claim 29, wherein the sequence of uplink grants comprises a periodic sequence of uplink grants.

34. The apparatus according to any claim 29, wherein the one or more intervening uplink grants do not align with the start of a fixed frame period for the first unlicensed radio channel, and are not within a channel occupancy time of a fixed frame period for the first unlicensed radio channel for which a successful channel access procedure by the apparatus is valid.

35. The apparatus according to claim 29, wherein the second unlicensed radio channel is one of a plurality of unlicensed radio channels including resource blocks for which the apparatus is configured by a radio access network node to make data transmissions, and wherein the start time of a next fixed frame period for the second unlicensed radio channel is earlier than the start times of next fixed frame periods for the other unlicensed radio channels of the plurality of unlicensed radio channels.

36. The apparatus according to claim 29, wherein attempting to transmit the data via the second unlicensed radio channel comprises attempting a channel access procedure for access to the second unlicensed channel in a fixed frame period starting in alignment with one of the one or more intervening uplink grants.

37. The apparatus according to claim 36, wherein the at least one memory and computer program code are configured to, with the at least one processor, cause the apparatus to: in response to the channel access procedure being successful, transmitting the data within a channel occupancy time starting at the start of the fixed frame period for the second unlicensed radio channel.

38. The apparatus according to claim 37, wherein the at least one memory and computer program code are configured to, with the at least one processor, cause the apparatus to: transmit further data via the second unlicensed radio channel at one more later uplink grants within the channel occupancy time starting at the start of the fixed frame period for the second unlicensed radio channel.

39. The apparatus according to claim 37, wherein the at least one memory and computer program code are configured to, with the at least one processor, cause the apparatus to: in response to having further data transmission-ready in time for transmission at a later uplink grant within the channel occupancy time of the fixed frame period for the second unlicensed radio channel after no data transmission at a preceding uplink grant within the channel occupancy time of the fixed frame period for the second unlicensed radio channel, attempt transmission of the further data via the second unlicensed radio channel.

40. The apparatus according to claim 37, wherein the at least one memory and computer program code are configured to, with the at least one processor, cause the apparatus to: in response to having further data transmission-ready in time for transmission at a later uplink grant within the channel occupancy time of the fixed frame period for the second unlicensed radio channel after no data transmission by the user equipment at a preceding uplink grant within the channel occupancy time of the fixed frame period for the second unlicensed radio channel, attempt transmission of the further data via the second unlicensed radio channel or via another unlicensed radio channel, depending on whether no data transmission at the preceding uplink grant was a result of no data being transmission-ready for transmission at the preceding uplink grant, or the result of a channel access failure to make a data transmission at the preceding uplink grant.

41. The apparatus according to claim 29, wherein the first and second unlicensed radio channels comprise 20 MHz channels.

42. The apparatus according to claim 41, wherein attempting to transmit the data via the second unlicensed radio channel comprises attempting to transmit the data via a set of resource blocks within the second 20 MHz channel.

43.-46. (canceled)
